(19) United States
(12) Patent Application Publication
(10) Pub. No.: US 2024/0263513 A1
(43) Pub. Date: Aug. 8, 2024

(54) BRACKET AND METHOD OF ATTACHING UPPER BEAM OF WINDOW BLIND TO THE BRACKET

(71) Applicant: UNION WINNER INTERNATIONAL CO., LTD., Taipei City (TW)

(72) Inventor: Ming-Tsung PAI, CAOTUN TOWNSHIP (TW)

(73) Assignee: UNION WINNER INTERNATIONAL CO., LTD., TAIPEI CITY (TW)

(21) Appl. No.: 18/118,388

(22) Filed: Mar. 7, 2023

(30) Foreign Application Priority Data
Feb. 2, 2023 (TW) 112200921

(51) Int. Cl. E06B 9/266

(52) U.S. Cl. CPC E06B 9/266

(57) ABSTRACT

A bracket, which is adapted for attachment of an upper beam of a window blind having opposite first and second walls provided with first and second linked portions respectively, includes a supporting plate and an abutting plate connected thereto. The supporting plate has a first buckling portion and a guiding sheet separate therefrom. The abutting plate has a second buckling portion. When the upper beam is attached to the bracket, the first linked portion of the upper beam is abutted on the guiding sheet of the supporting plate and embedded in the first buckling portion of the supporting plate, the second wall of the upper beam is abutted on the abutting plate, and the second linked portion of the upper beam is embedded in the second buckling portion of the abutting plate. Besides, the present invention provides a method of attaching the upper beam to the bracket.

### BACKGROUND OF THE INVENTION

### 1. Field of the Invention

The present invention relates to window blinds and more particularly, to a bracket for attachment of an upper beam of a window blind, and a method of attaching an upper beam of a window blind to the aforementioned bracket.

### 2. Description of the Related Art

The commercially available window blinds, such as venetian blinds or cellular blinds, usually have an upper beam. During the attachment of the upper beam, a plurality of brackets should be fixed to the wall, frame or ceiling in advance, and then the upper beam is linked to a plurality of brackets for fixing. In the traditional upper beam attachment manner, the bottom of the upper beam should be firstly buckled with the bracket, and then the top of the upper beam is buckled with the bracket. Therefore, it is difficult to perform the attachment of the heavy and wide upper beam by only one person. In particular, the top of the upper beam being buckled with the bracket additionally has difficulty of positioning the upper beam with the bracket. Therefore, the configuration design of the bracket and the traditional upper beam attachment manner still need improvement.

### SUMMARY OF THE INVENTION

The present invention has been accomplished in view of the above-noted circumstances. It is a primary objective of the present invention to provide a bracket which is simple in structure and easy for the attachment of the upper beam.

To attain the above primary objective, the present invention provides a bracket which is adapted for attachment of an upper beam of a window blind. The upper beam has a first wall and a second wall opposite to the first wall. The first wall has a first linked portion. The second wall has a second linked portion. The bracket of the present invention includes a supporting plate and an abutting plate. An end of the supporting plate has a first buckling portion and a guiding sheet arranged separately from the first buckling portion. The abutting plate is connected to another end of the supporting plate and has a second buckling portion.

By the above-described technical features, the bracket of the present invention enables the installer to firstly make the first linked portion of the upper beam and the first buckling portion of the bracket engage with each other, and then make the second linked portion of the upper beam and the second buckling portion of the bracket engage with each other. Comparing this with the configuration design of the traditional bracket, the bracket of the present invention makes it easier to position the upper beam attached thereto, and the bracket of the present invention can bear the weight of the upper beam, thereby effort-saving for the installer during the attachment of the upper beam.

Preferably, the first buckling portion of the supporting plate has an extending part and a first hook part connected to the extending part; the guiding sheet of the supporting plate has a connecting portion and an abutting portion connected to the connecting portion; the first linked portion of the upper beam is abutted on the abutting portion of the guiding sheet and embedded in the first hook part of the first buckling portion.

Preferably, the abutting portion of the guiding sheet of the supporting plate has a bump; the first linked portion of the upper beam is abutted on the bump.

Preferably, the second buckling portion of the abutting plate has an inclined body part and a second hook part connected to the inclined body part; the second linked portion of the upper beam is embedded in the second hook part of the second buckling portion.

Preferably, the abutting plate further includes a positionally limiting part; the positionally limiting part is connected to the second hook part and inclinedly extending in opposite direction to the inclined body part.

Preferably, the supporting plate includes two aforementioned guiding sheets; the guiding sheets are arranged by two sides of the first buckling portion respectively. It is a secondary objective of the present invention to provide a method of attaching the upper beam of the window blind to the aforementioned bracket, which is easy in operation.

To attain the above secondary objective, the method of the present invention includes the steps of: a) fixing the bracket; b) making the first linked portion of the upper beam abutted on the guiding sheet of the supporting plate and embedded in the first buckling portion of the supporting plate; and c) rotating the upper beam by taking the first linked portion of the upper beam as a fulcrum to make the second wall of the upper beam abutted on the abutting plate of the bracket and make the second linked portion of the upper beam embedded in the second buckling portion of the abutting plate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The bracket and the method of attaching an upper beam to the aforementioned bracket, which are provided by the present invention, will be further described in the following embodiments in coordination with the figures, and wherein:

FIG. 1 is an assembled perspective view of brackets of a first embodiment of the present invention and an upper beam of a window blind;

FIG. 2 is a top perspective view of the bracket of the first embodiment of the present invention;

FIG. 3 is a bottom perspective view of the bracket of the first embodiment of the present invention;

FIG. 4 is a side view of the bracket of the first embodiment of the present invention;

FIG. 5 is a flow chart of the method of the present invention;

FIG. 6 is a side view of the bracket of the first embodiment of the present invention and the upper beam, showing that a first linked portion of the upper beam is embedded in a first buckling portion of the bracket;

FIG. 7 is similar to FIG. 6, showing that a second linked portion of the upper beam is embedded in a second buckling portion of the bracket;

FIG. 8 is a perspective view of a bracket of a second embodiment of the present invention;

FIG. 9 is a side view of the bracket of the second embodiment of the present invention and the upper beam, showing that the first linked portion of the upper beam is embedded in a first buckling portion of the bracket;

FIG. 10 is similar to FIG. 9, showing that the second linked portion of the upper beam is embedded in a second buckling portion of the bracket;

FIG. 11 is a perspective view of a bracket of a third embodiment of the present invention;

FIG. 12 is a side view of a bracket of a fourth embodiment of the present invention and another upper beam, showing that a first linked portion of the upper beam is embedded in a first buckling portion of the bracket; and

FIG. 13 is similar to FIG. 12, showing that a second linked portion of the upper beam is embedded in a second buckling portion of the bracket.

### DETAILED DESCRIPTION OF THE INVENTION

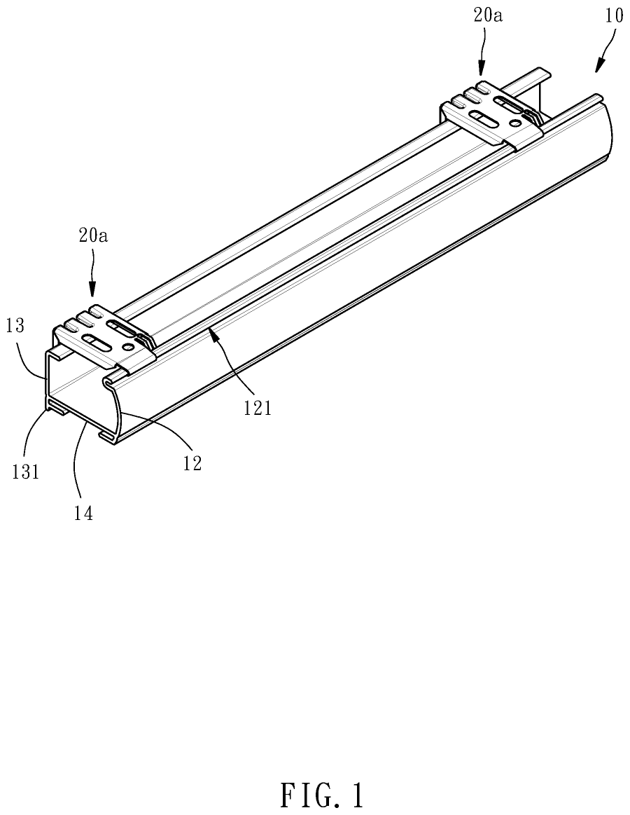

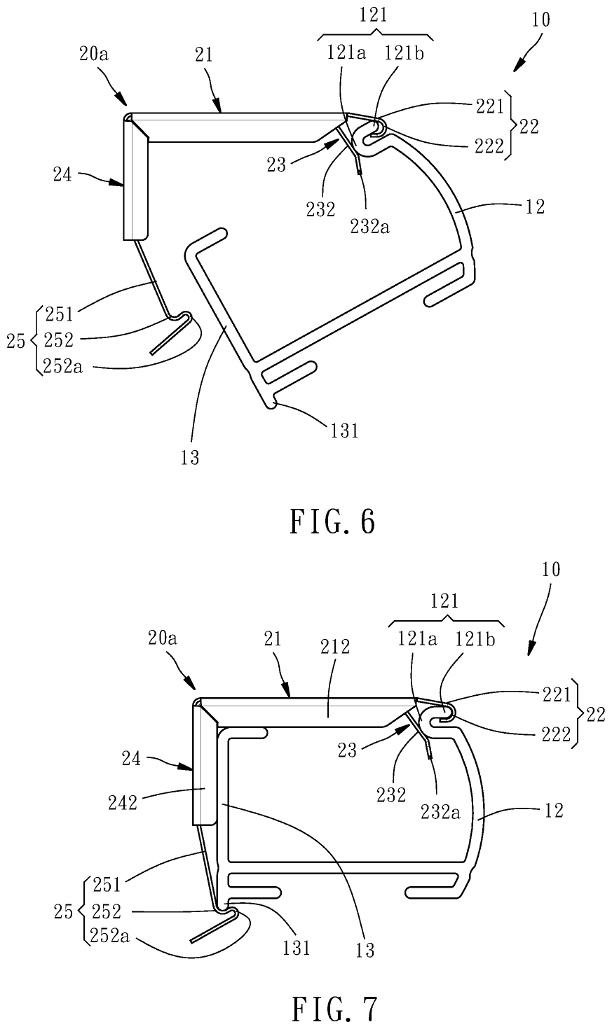

Referring to FIG. 1, it is primarily shown in FIG. 1 that when a bracket 20a of a first embodiment of the present invention is attached to an upper beam 10 of a window blind, two ends of the upper beam 10 are each arranged with a bracket 20a. However, in practice, the arrangement may include only one bracket 20a of the first embodiment of the present invention. Referring to FIG. 1, FIG. 6 and FIG. 7, the upper beam 10 includes a first wall 12, a second wall 13 opposite to the first wall 12, and a connecting plate 14 connecting the first wall 12 with the second wall 13. The top edge of the first wall 12 has a first linked portion 121. The first linked portion 121 has an inner edge part 121a and an outer edge part 121b connected to the inner edge part 121a. The bottom edge of the second wall 13 has a second linked portion 131.

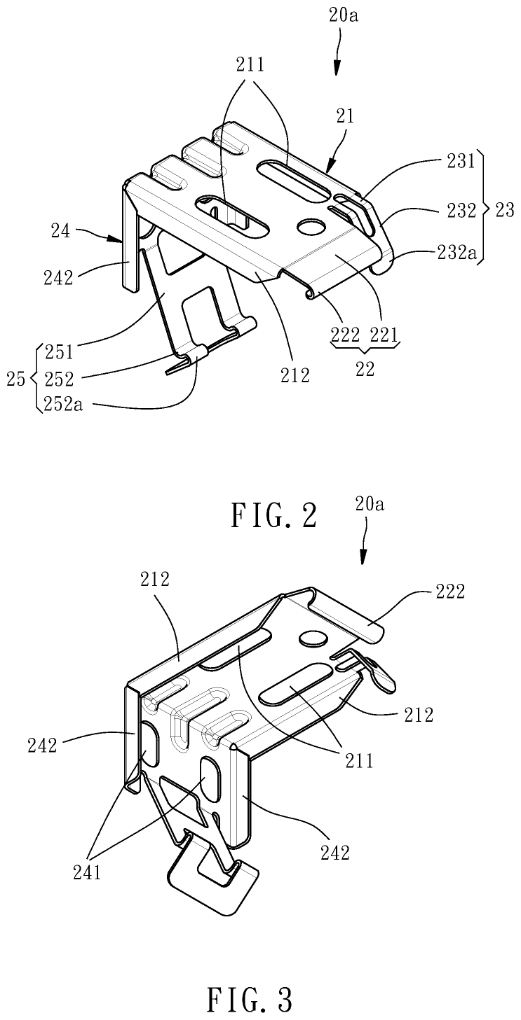

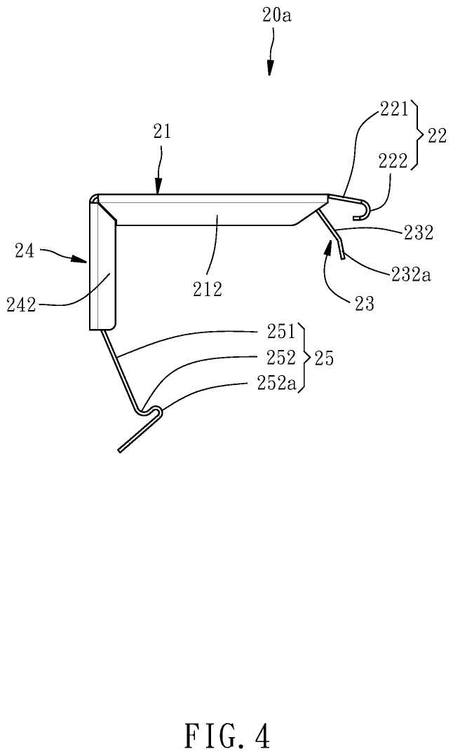

Referring to FIG. 2 to FIG. 4, the bracket 20a of the first embodiment of the present invention is an integrally made structure, which has a supporting plate 21 and an abutting plate 24.

The supporting plate 21 has two first positioning holes 211 penetrating therethrough. The left edge and right edge of the supporting plate 21 each have a first wing 212 extending downward. The front edge of the supporting plate 21 has a first buckling portion 22 and a guiding sheet 23. The first buckling portion 22 has an extending part 221 slightly inclined downward, and a first hook part 222 connected to the extending part 221. The guiding sheet 23 has a connecting portion 231 extending horizontally, and an abutting portion 232 inclined downward and connected to the connecting portion 231. An end part 232a of the abutting portion 232 is bent downward.

The abutting plate 24 is perpendicularly connected to the rear edge of the supporting plate 21, and the abutting plate 24 has two second positioning holes 241 penetrating therethrough. The left edge and right edge of the abutting plate 24 each have a second wing 242 extending frontward. Each second wing 242 and each first wing 212 are connected with each other. Besides, the bottom end of the abutting plate 24 has a second buckling portion 25. The second buckling portion 25 has an inclined body part 251, a second hook part 252 connected to the inclined body part 251, and a positionally limiting part 252a connected to the second hook part 252 and inclinedly extending in opposite direction to the inclined body part 251.

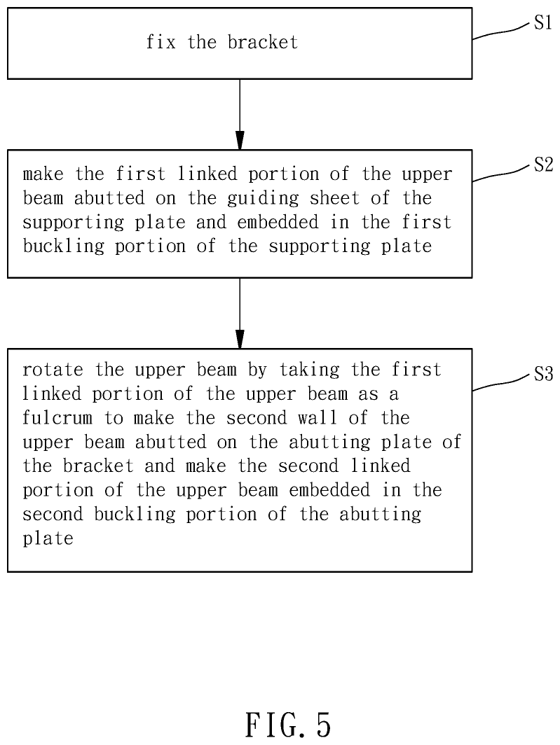

The structural features of the bracket 20a of the first embodiment of the present invention are described above. The method of attaching the upper beam 10 to the bracket 20a of the first embodiment of the present invention will be further described hereinafter. Referring to FIG. 5, the method includes the following steps.

a) As the step S1 shown in FIG. 5, fix the bracket 20a.

In this step, the installer inserts a plurality of screws (not shown) through the first positioning holes 211 and the second positioning holes 241 of the bracket 20a to fasten the bracket 20a to a place such as a wall, window frame or ceiling. The place where the bracket 20a is fixed is unlimited herein.

b) As the step S2 shown in FIG. 5, make the first linked portion 121 of the upper beam 10 abutted on the guiding sheet 23 of the supporting plate 21 and embedded in the first buckling portion 22 of the supporting plate 21.

In this step, as shown in FIG. 6, at first the upper beam 10 is slightly inclined and the inner edge part 121a of the first linked portion 121 is abutted on the abutting portion 232 of the guiding sheet 23 to make the abutting portion 232 of the guiding sheet 23 pushed by the inner edge part 121a of the first linked portion 121 to slightly elastically displace backward, resulting in that the outer edge part 121b of the first linked portion 121 is embedded in the first hook part 222 of the first buckling portion 22. An elastic restoring force is stored by the abutting portion 232 of the guiding sheet 23 pushed by the inner edge part 121a of the first linked portion 121. Therefore, when the outer edge part 121b of the first linked portion 121 is embedded in the first hook part 222 of the first buckling portion 22, the abutting portion 232 of the guiding sheet 23 is no longer pushed by the inner edge part 121a of the first linked portion 121. Meanwhile, the elastic restoring force acts on the abutting portion 232 of the guiding sheet 23 to push the inner edge part 121a of the first linked portion 121, resulting in that the inner edge part 121a of the first linked portion 121 is pushed by the abutting portion 232 of the guiding sheet 23 and the outer edge part 121b of the first linked portion 121 is stably embedded in the first hook part 222 of the first buckling portion 22.

c) As the step S3 shown in FIG. 5, rotate the upper beam 10 by taking the first linked portion 121 of the upper beam 10 as a fulcrum to make the second wall 13 of the upper beam 10 abutted on the abutting plate 24 of the bracket 20a and make the second linked portion 131 of the upper beam 10 embedded in the second buckling portion 25 of the abutting plate 24.

In this step, as shown in FIG. 7, because the first linked portion 121 of the upper beam 10 has engaged with the first buckling portion 22 of the bracket 20a, the installer can rotate the upper beam 10 clockwise by taking the first linked portion 121 as the fulcrum to make the second wall 13 of the upper beam 10 abutted on the abutting plate 24 of the bracket 20a and make the second wall 13 positioned between the first wings 212 of the supporting plate 21 and the second wings 242 of the abutting plate 24. On the other hand, the second linked portion 131 of the upper beam 10 is abutted on the second buckling portion 25 of the bracket 20a, making the inclined body part 251 of the second buckling portion 25 pushed by the second linked portion 131 to slightly displace backward, resulting in that the second linked portion 131 is embedded in the second hook part 252 of the second buckling portion 25. Meanwhile, the second linked portion 131 is blocked by the positionally limiting part 252a of the second buckling portion 25, thereby prevented from escaping from the second hook part 252 of the second buckling portion 25, such that the upper beam 10 is installed on the bracket 20a. The installer can detach the upper beam 10 from the bracket 20a by reversely performing the above-described step S3 and step S2.

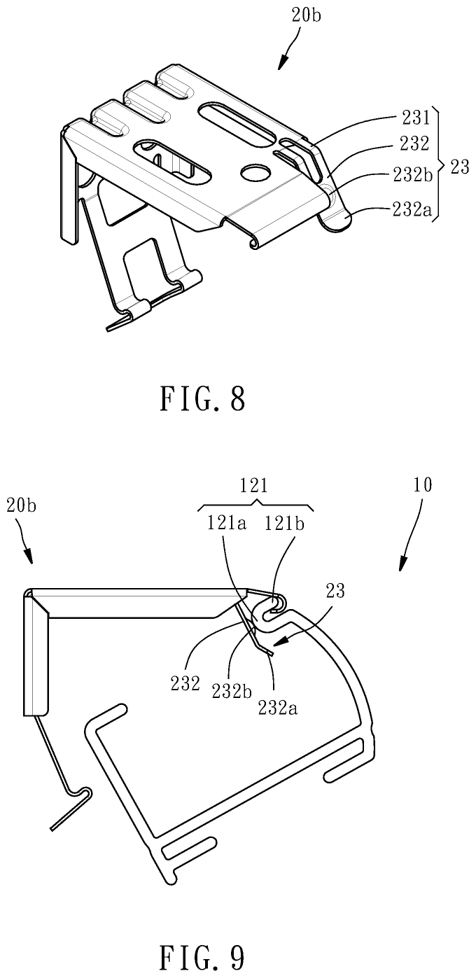

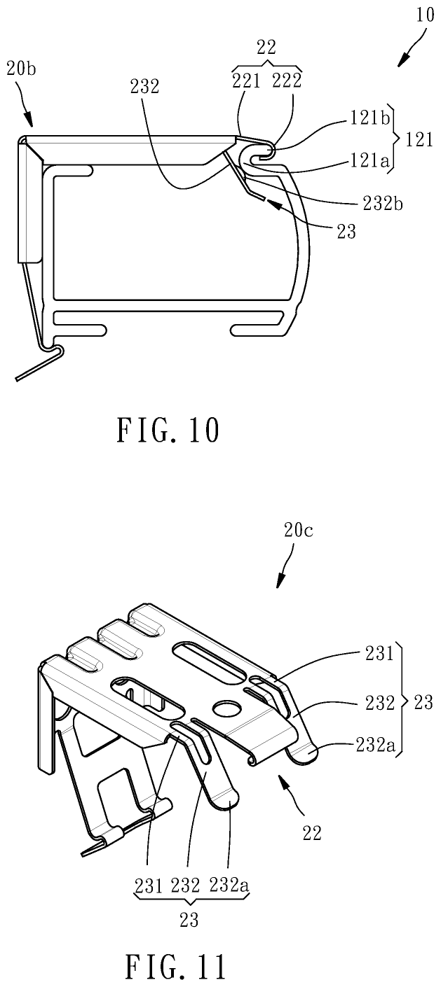

However, the bracket 20a is unlimited to that disclosed in this embodiment. Referring to FIG. 8, a bracket 20b of a second embodiment of the present invention is approximately the same in structure with the first embodiment, but has the difference that the end part 232a of the abutting portion 232 of the guiding sheet 23 is bent upward and the abutting portion 232 has a bump 232b. When the upper beam 10 is attached to the bracket 20b of the second embodiment of the present invention by the above-described method, as shown in FIG. 9 and FIG. 10, the inner edge part 121a of the first linked portion 121 of the upper beam 10 is abutted on the bump 232b of the guiding sheet 23. The design with the bump 232b enables the installer to affirm whether the upper beam 10 is presently attached at the correct position, making it easier to embed the outer edge part 121b of the first linked portion 121 of the upper beam 10 in the first hook part 222 of the first buckling portion 22 of the bracket 20b. The other steps are completely the same with those in the above-described first embodiment, thereby not repeatedly described here.

Referring to FIG. 11, a bracket 20c of a third embodiment of the present invention is approximately the same in structure with the first embodiment, but the difference therebetween is that the bracket 20c of the third embodiment of the present invention includes two guiding sheets 23. The guiding sheets 23 are arranged by two sides of the first buckling portion 22 respectively, and the end part 232a of the abutting portion 232 of each guiding sheet 23 is bent upward. When the upper beam 10 is attached to the bracket 20c of the third embodiment of the present invention by the above-described method, the inner edge part 121a of the first linked portion 121 of the upper beam 10 is abutted on the abutting portions 232 of the guiding sheets 23. The inner edge part 121a of the first linked portion 121 is pushed by the abutting portions 232 of the guiding sheets 23, so that it is easier to embed the outer edge part 121b of the first linked portion 121 in the first hook part 222 of the first buckling portion 22. The other steps are completely the same with those in the above-described first embodiment, thereby not repeatedly described here.

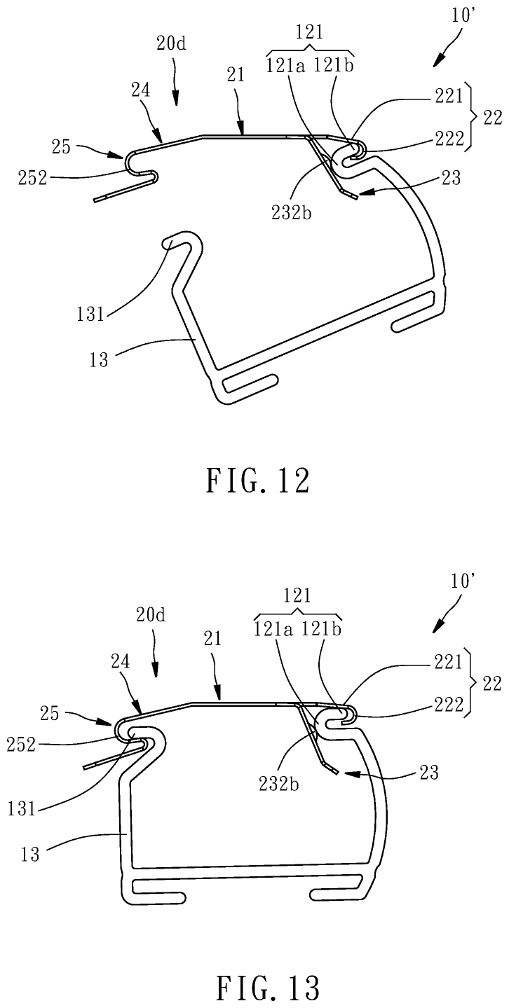

Referring to FIG. 12 and FIG. 13, a bracket 20d of a fourth embodiment of the present invention is approximately the same in structure with the second embodiment, but the difference therebetween is that the abutting plate 24 in this embodiment is slightly inclinedly connected to the rear edge of the supporting plate 21. Besides, the upper beam 10′ in this embodiment is approximately the same in structure with the upper beam 10, but the primary difference therebetween is that the second linked portion 131 of the upper beam 10′ is located at the top edge of the second wall 13. When the upper beam 10′ is attached to the bracket 20d of the fourth embodiment of the present invention by the above-described method, the inner edge part 121a of the first linked portion 121 of the upper beam 10′ is abutted on the bump 232b of the guiding sheet 23 to make the outer edge part 121b of the first linked portion 121 of the upper beam 10′ embedded in the first hook part 222 of the first buckling portion 22, and then the upper beam 10′ is rotated clockwise by taking the first linked portion 121 as the fulcrum to make the second linked portion 131 of the upper beam 10′ embedded in the second hook part 252 of the second buckling portion 25, such that the upper beam 10′ is installed on the bracket 20d of the fourth embodiment of the present invention. The installer can detach the upper beam 10′ from the bracket 20d of the fourth embodiment of the present invention by reversely performing the above-described steps.

In conclusion, the bracket 20a, 20b, 20c of the present invention enables the installer to firstly make the first linked portion 121 of the upper beam 10 and the first buckling portion 22 of the bracket 20a, 20b, 20c of the present invention engage with each other, and then make the second linked portion 131 of the upper beam 10 and the second buckling portion 25 of the bracket 20a, 20b, 20c of the present invention engage with each other. The bracket 20d of the present invention enables the installer to make the first linked portion 121 of the upper beam 10′ and the first buckling portion 22 of the bracket 20d of the present invention engage with each other, and then make the second linked portion 131 of the upper beam 10′ and the second buckling portion 25 of the bracket 20d of the present invention engage with each other. Comparing these with the configuration design of the traditional bracket, the bracket 20a, 20b, 20c of the present invention makes it easier to position the upper beam 10 attached thereto, and the same effect is also attained by the bracket 20d of the present invention for the upper beam 10′ attached thereto. Besides, the bracket 20a, 20b, 20c, 20d of the present invention can bear the weight of the upper beam 10, 10′ (and bear the weight of the window blind), thereby effort-saving for the installer during the attachment of the upper beam 10, 10′.

What is claimed is:

1. A bracket, which is adapted for attachment of an upper beam of a window blind, the upper beam having a first wall and a second wall opposite to the first wall, the first wall having a first linked portion, the second wall having a second linked portion, the bracket comprising:
a supporting plate, an end of the supporting plate having a first buckling portion and a guiding sheet arranged separately from the first buckling portion; and
an abutting plate connected to another end of the supporting plate, the abutting plate having a second buckling portion;
wherein, when the upper beam is attached to the bracket, the first linked portion of the first wall of the upper beam is abutted on the guiding sheet of the supporting plate and embedded in the first buckling portion of the supporting plate, the second wall of the upper beam is abutted on the abutting plate, and the second linked portion of the second wall of the upper beam is embedded in the second buckling portion of the abutting plate.

2. The bracket as claimed in claim 1, wherein the first buckling portion of the supporting plate has an extending part and a first hook part connected to the extending part; the guiding sheet of the supporting plate has a connecting portion and an abutting portion connected to the connecting portion; the first linked portion of the upper beam is abutted on the abutting portion of the guiding sheet and embedded in the first hook part of the first buckling portion.

3. The bracket as claimed in claim 2, wherein the abutting portion of the guiding sheet has a bump; the first linked portion of the upper beam is abutted on the bump.

4. The bracket as claimed in claim 1, wherein the second buckling portion of the abutting plate has an inclined body part, and a second hook part connected to the inclined body part; the second linked portion of the upper beam is embedded in the second hook part of the second buckling portion.

5. The bracket as claimed in claim 4, wherein the abutting plate further comprises a positionally limiting part; the positionally limiting part is connected to the second hook part and inclinedly extending in opposite direction to the inclined body part.

6. The bracket as claimed in claim 1, wherein the supporting plate comprises two said guiding sheets; the guiding sheets are arranged by two sides of the first buckling portion respectively.

7. A method of attaching an upper beam of a window blind to the bracket as claimed in claim 1, the method comprising the steps of:
a) fixing the bracket;
b) making the first linked portion of the upper beam abutted on the guiding sheet of the supporting plate and embedded in the first buckling portion of the supporting plate; and
c) rotating the upper beam by taking the first linked portion of the upper beam as a fulcrum to make the second wall of the upper beam abutted on the abutting plate of the bracket and make the second linked portion of the upper beam embedded in the second buckling portion of the abutting plate.

8. The method as claimed in claim 7, wherein in the step b), the abutting portion of the guiding sheet has a bump, and the first linked portion of the upper beam is abutted on the bump.

9. The method as claimed in claim 7, wherein in the step b), the supporting plate comprises two said guiding sheets, and the guiding sheets are arranged by two sides of the first buckling portion respectively.
